(19) United States
(12) Patent Application Publication
(10) Pub. No.: US 2018/0039425 A1
(43) Pub. Date: Feb. 8, 2018

(54) METHOD AND APPARATUS FOR IMPROVED FLASH MEMORY STORAGE LATENCY AND ROBUSTNESS

(71) Applicant: Alibaba Group Holding Limited, George Town (KY)

(72) Inventor: Shu LI, Santa Clara, CA (US)

(21) Appl. No.: 15/226,459

(22) Filed: Aug. 2, 2016

(51) Int. Cl. G06F 3/06

(52) U.S. Cl. CPC G06F 3/0611; G06F 3/0688; G06F 3/0619

(57) ABSTRACT

Performance of memory storage systems is enhanced by reducing the occurrence of long-tail reads and predictively building data interconnections to shorten average read latencies and increase memory storage system robustness. Erasure coding procedures can be performed to develop a correlation among different data fragments and form data groupings. Data grouping procedures can be performed to restore data to an original form in the event that a memory storage device is temporarily or permanently unavailable for data read requests. Minimum distance separation (MDS) code potential can be exploited to read the least amount of data fragments required to predicatively retrieve read results instead of directly reading from physical pages.

### BACKGROUND

In general, the read latency of a solid state drive (SSD) cannot be a constant and can vary based on different work conditions from time to time. Indeed, SSD read latencies occasionally include periods of extremely long read latencies or “long-tail reads” which are unacceptable delays that occur at the application level. Long-tail reads are especially problematic to computer system infrastructures that place a heavy emphasis on faster memory storage system response times. Conventional approaches often fail to efficiently retrieve data stored in a memory storage device, such as a NAND die, due to their failure in reducing the occurrence of these long-tail reads in the first place. Moreover, these conventional approaches are also inefficient when performing data read procedures due to the die being locked as a result of being erased, die malfunction, inherent ECC failures, or similar issues.

### SUMMARY

Embodiments of the present disclosure enhance the performance of memory storage systems by reducing the occurrence of long-tail reads and predictively building data interconnections to shorten average read latencies and increase memory storage system robustness. Embodiments of the present disclosure perform erasure coding procedures to develop a correlation among different data fragments and form data groupings.

Data grouping procedures performed by embodiments of the present disclosure restore data to an original form in the event that a memory storage device is temporarily or permanently unavailable for data read requests. Embodiments of the present disclosure can exploit minimum distance separation (MDS) code potential and read the least amount of data fragments required to predicatively retrieve read results instead of directly reading from physical pages.

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification, and in which like numerals depict like elements, illustrate embodiments of the present disclosure and, together with the description, serve to explain the principles of the disclosure.

FIG. 1A is a block diagram depicting an example of a computer system components for reducing memory storage latency and improving robustness in accordance with embodiments of the present disclosure.

FIG. 1B is a block diagram depicting an example of a hardware configuration for reducing memory storage latency and improving memory storage robustness in accordance with embodiments of the present disclosure.

FIG. 1C illustrates an example of a circuit that can be used to implement erasure coding for parity generation in accordance with embodiments of the present disclosure.

FIG. 1D illustrates an example of a memory storage system configuration with multiple channels and multiple NAND flash dies in accordance with embodiments of the present disclosure.

FIG. 1E illustrates an example of a data path included in a memory storage system in accordance with embodiments of the present disclosure.

FIG. 2A is a block diagram depicting an example of a data fragmentation process for performing data restoration procedures in accordance with embodiments of the present disclosure.

FIG. 2B is a block diagram depicting an example of a data grouping procedure in accordance with embodiments of the present disclosure.

FIG. 2C is another block diagram depicting an example of a data grouping procedure in accordance with embodiments of the present disclosure.

FIG. 3 is a flowchart of a process for reducing memory storage latency and improving memory storage robustness in accordance with embodiments of the present disclosure.

FIG. 4A is a first portion of a flowchart of an exemplary process for performing data fragmenting and data grouping procedures in accordance with embodiments of the present disclosure.

FIG. 4B is a second portion of a flowchart of an exemplary process for performing data fragmenting and data grouping procedures in accordance with embodiments of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications, and equivalents which can be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure can be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

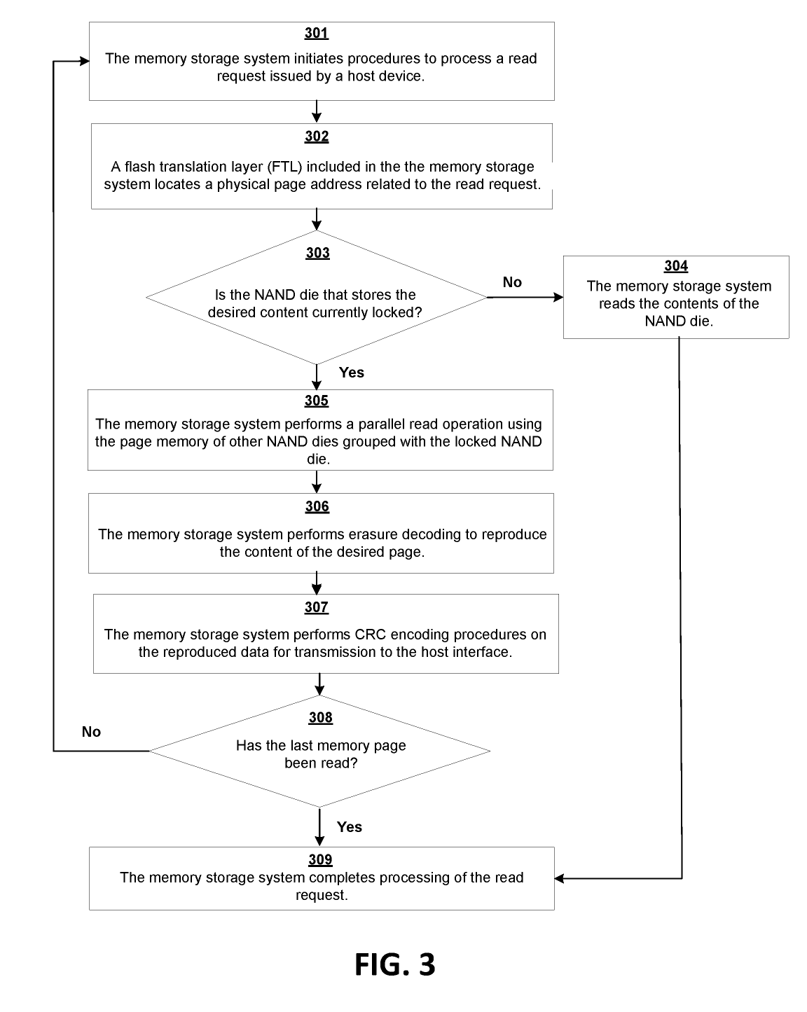

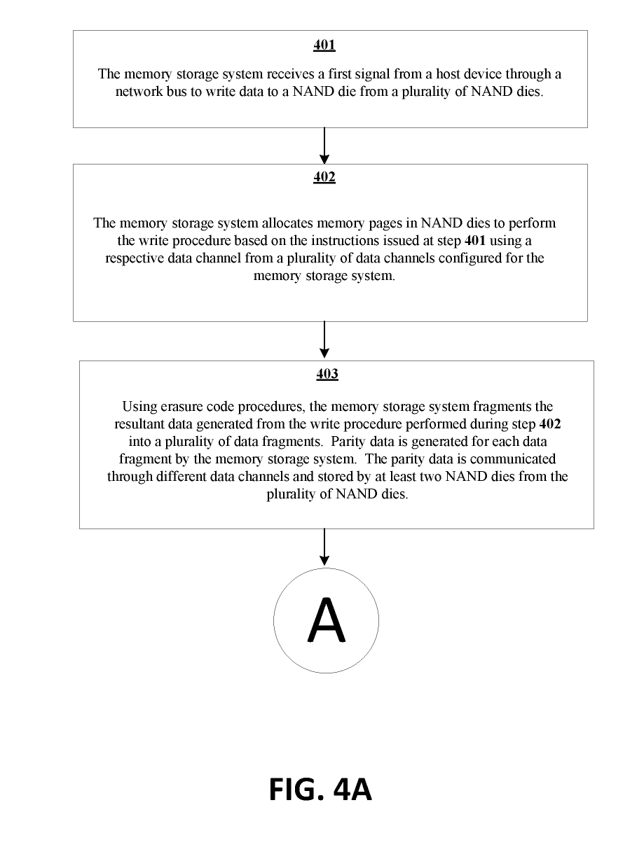

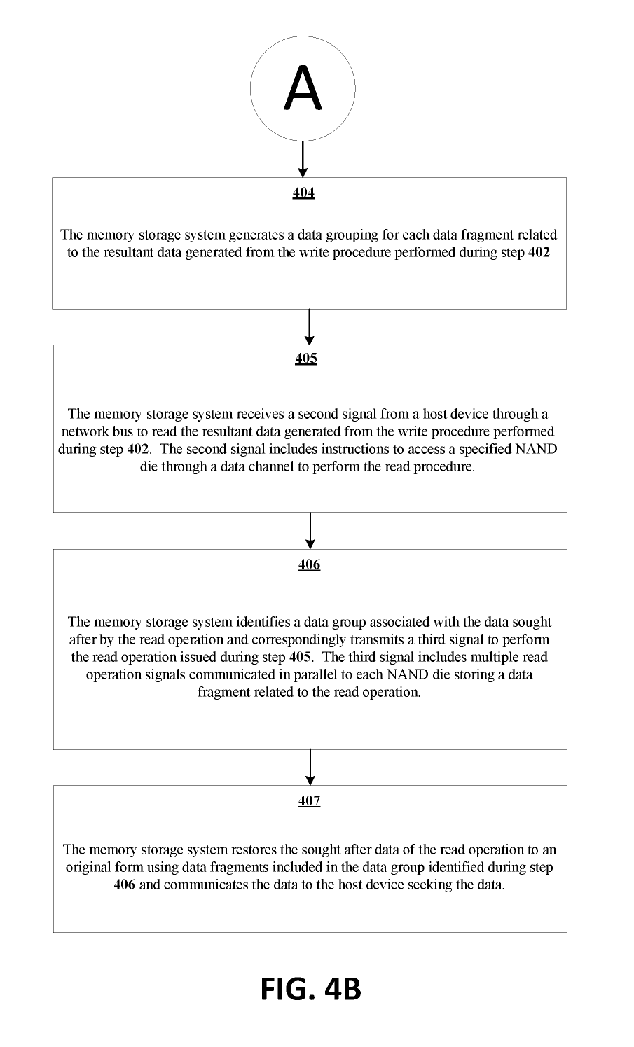

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “fragmenting,” “storing,” “reading,” “writing,” “erasing,” “compressing,” “decompressing,”, “encoding”, “decoding”, “encrypting,” “decrypting,” “error correction encoding,” “error correction decoding,” “generating,” “restoring,” “grouping,” or the like, refer to actions and processes (e.g., FIG. 3, FIG. 4A, FIG. 4B) of an apparatus or computer system or similar electronic computing device or processor. A computer system or similar electronic computing device manipulates and transforms data represented as physical (electronic) quantities within memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

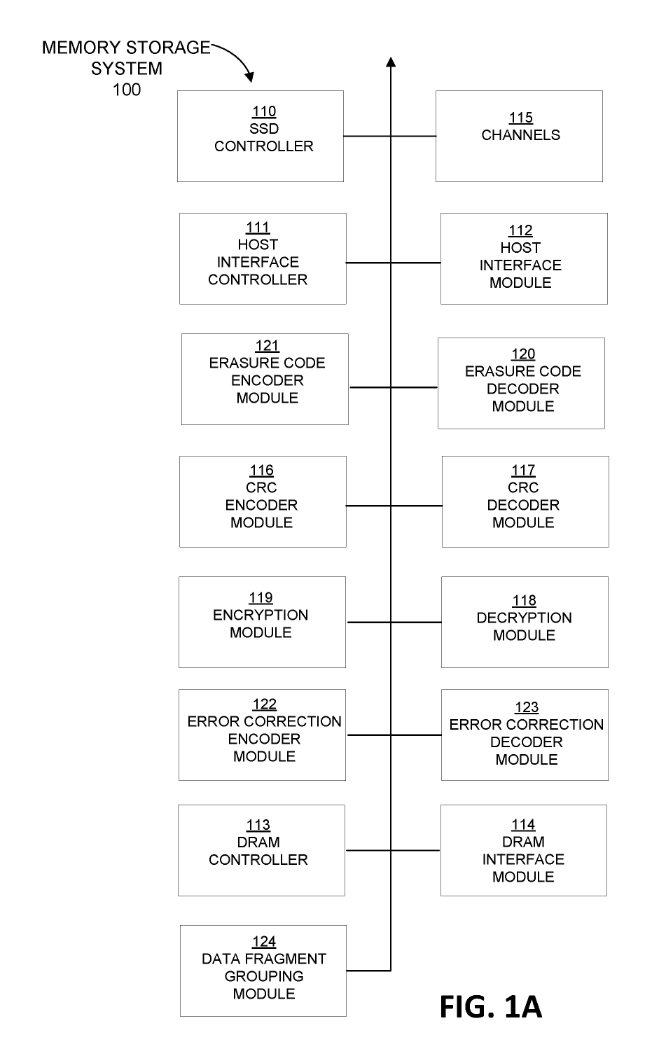

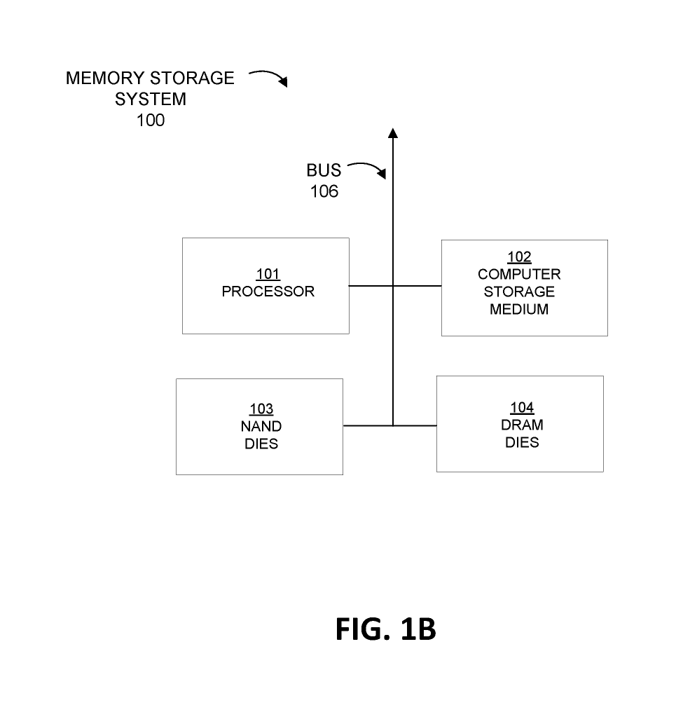

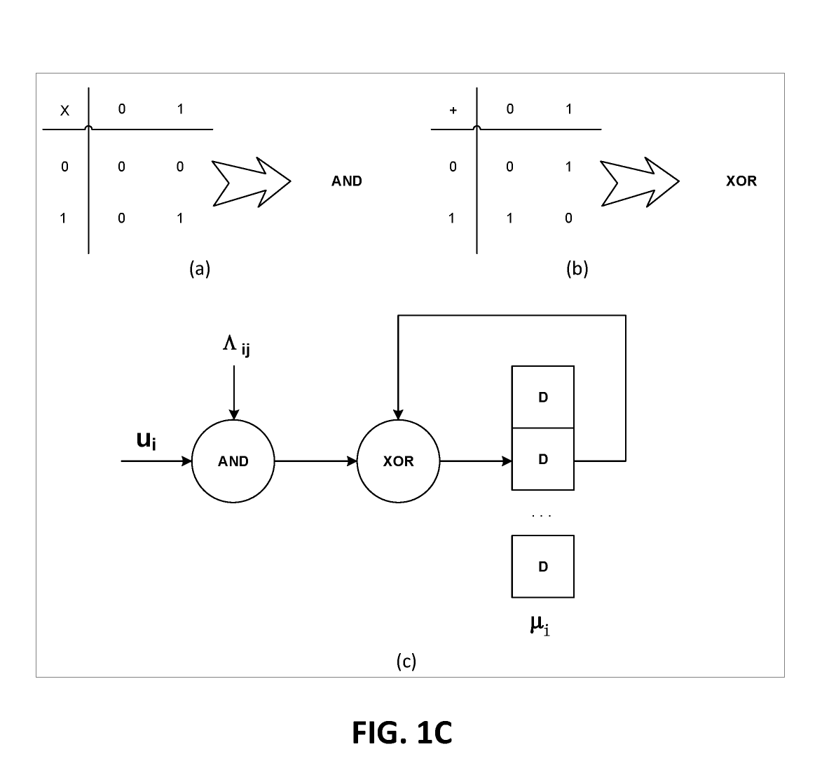

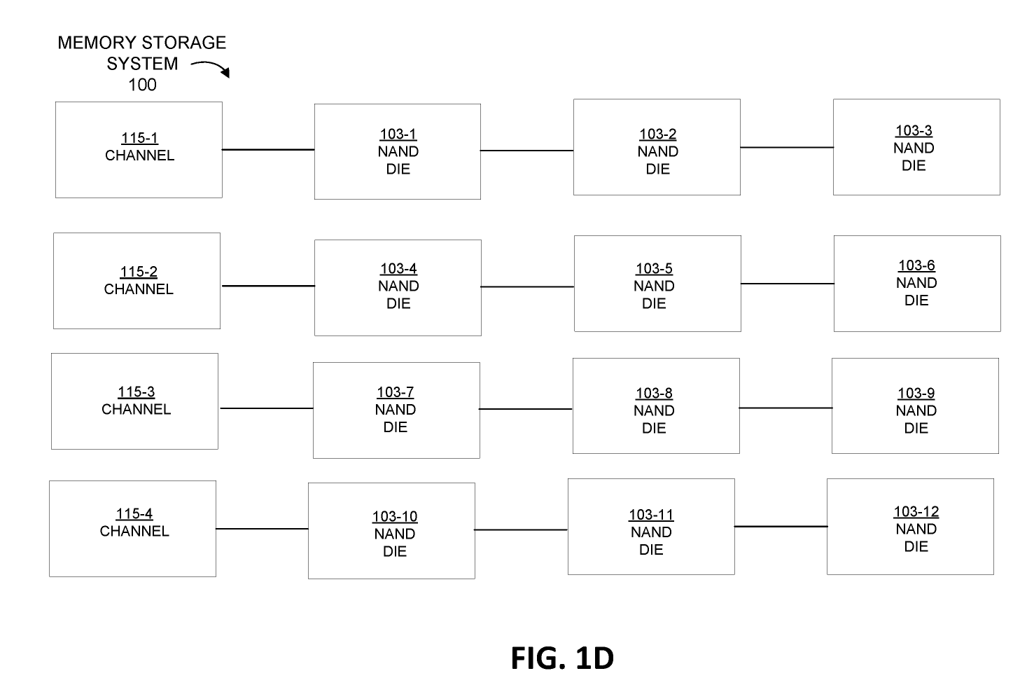

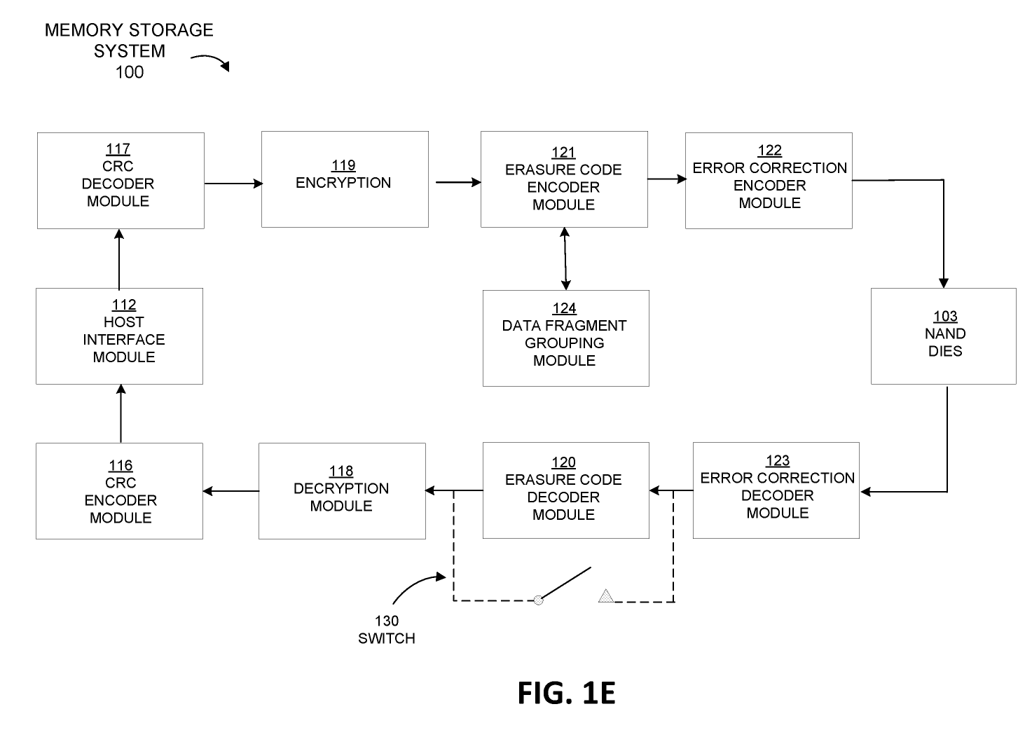

FIG. 1A is a block diagram depicting an example of a computer system components for reducing memory storage latency and improving robustness in accordance with embodiments of the present disclosure. Although specific components are disclosed in FIG. 1A, it should be appreciated that such components are exemplary. That is, embodiments of the present disclosure are well suited to having various other components or variations of the components recited in FIG. 1A. It is appreciated that the components in FIG. 1A can operate with other components than those presented, and that not all of the components described in FIG. 1A are required to achieve the goals of the present disclosure. According to some embodiments, components depicted within FIG. 1A can be combined to achieve the goals of the present disclosure. Furthermore, it is appreciated that some components described in FIG. 1A can operate in combination with some components described in FIG. 1B (discussed infra) for purposes of achieving the goals of the present disclosure.

Memory storage system 100 can be implemented as an electronic device capable of communicating with other electronic devices over a data communications bus. The exemplary memory storage system 100, upon which embodiments of the present disclosure may be implemented, includes a general purpose computing system environment. For example, as illustrated in FIG. 1A, memory storage system 100 generally includes SSD controller 110, host interface module 112, host interface controller 111, dynamic random access memory (DRAM) interface module 114, DRAM controller 113, a number of different data channels 115 (referred to hereinafter as “channels” 115), CRC encoder module 116, CRC decoder module 117, encryption module 119, decryption module 118, erasure code encoder module 121, erasure code decoder module 120, data fragment grouping module 124, error correction encoder module 122, and error correction decoder module 123.

SSD controller 110 includes the functionality to send and receive signals from one or more host devices through an interface, such as host interface module 112 (e.g., an Open NAND Interface, ONFI, etc.) Host interface module 112 is configured by memory storage system 100 using host interface controller 111. In this fashion, host interface controller 111 configures host interface module 112 to enable communications between one or more host devices and memory storage system 100.

For example, SSD controller 110 receives data write and/or read procedure requests from a host device through host interface module 112. These data write procedures can be instructions for a particular memory storage device, such as a NAND die, to perform a write operation. SSD controller 110 includes the functionality to generate and/or process chip select signals to locate, address, and/or activate a particular NAND die to perform data write and/or read procedures.

SSD controller 110 also includes the functionality to send multiple different control signals to other components of memory storage system 100 to perform further procedures related to data write procedures issued by a host device. For example, read command operations issued by an application to read the resultant data generated by a write command can be sent in parallel by SSD controller 110 to multiple NAND dies storing data related to the resultant data. When issuing parallel read operations, SSD controller 110 selects NAND dies belonging to grouped data sets created by data fragment grouping module 124 (discussed in greater detail infra). As such, NAND dies can be configured by memory storage system 100 to store data related to the desired data in a manner such that it can still be retrieved despite the unavailability of a targeted NAND die at the time of the read command's issuance.

In some embodiments, host interface controller 111 executes or includes a flash translation layer (FTL), which may be implemented in firmware or as software. In this manner, host interface controller 111 configures host interface module 112 to translate logical addresses from a host system to physical addresses. Host interface module 112 includes, for example, a physical layer (PHY) interface and/or serializer/deserializer that converts data between analog and digital domains (e.g., from analog to digital, and from digital to analog).

DRAM interface module 114 includes the functionality to enable DRAM controller 113 to access DRAM devices. In this fashion, DRAM interface module 114 uses configurations determined by DRAM controller 113 to enable a host device to map DRAM devices into virtual memory space for a particular resource or I/O device. As such, other host devices and/or other devices can perform read and/or write data procedures involving DRAM devices using DRAM controller 113 and/or DRAM interface module 114.

Channels 115 include a number of different data channels in which each data channel includes the functionality to communicate signals to and from SSD controller 110. SSD controller 110 uses a data channel from channels 115 to send and receive signals from memory storage devices, such as NAND dies, DRAM dies, etc., through multiple data channels. Channels 115 can be pre-configured as multi-bit ports, such as 8-bit ports, which enable SSD controller 110 to perform read and/or write operations using multiple different memory storage devices. In this fashion, SSD controller 110 includes the functionality to manage external storage devices such that memory storage devices can drive signals received through channels 115 to other portions of memory storage system 100. In order to fully utilize the internal bandwidth of memory storage system 100, NAND dies can be spread across multiple data channels (see, e.g., FIG. 1D described herein).

CRC encoder module 116 includes the functionality to encode data generated by decryption module 118 with CRC code prior to being sent out to a host device. In this fashion, encoded data generated by CRC encoder module 116 encodes data for transfer quality assurance. CRC decoder module 117 includes the functionality to receive data through host interface module 112. CRC decoder module 117 also includes the functionality to perform conventional CRC decoding procedures. Using these procedures, CRC decoder module 117 determines whether data received from host interface module 112 includes CRC errors.

Encryption module 119 includes the functionality to encrypt resultant data generated from CRC decoder module 117 to produce encrypted data. The encrypted data generated by encryption module 119 is protected with information security so that unauthorized users are prevented from gaining access to data generated from CRC decoder module 117. Encryption module 119 also includes the functionality to generate keys when performing data encryption procedures.

Decryption module 118 includes the functionality to decrypt the encrypted data received and/or generated by memory storage system 100. For instance, in one embodiment, decryption module 118 includes the functionality to use encryption keys to perform decryption procedures. In this fashion, decryption module 118 is configured to perform decryption procedures during a read operations performed on resultant data stored in memory storage devices.

Erasure code encoder module 121 includes the functionality to fragment data into a number of different data fragments (“original data fragments”) that includes encoded redundant data portions. For instance, erasure code encoder module 121 includes the functionality to generate data, such as parity data, that allows memory storage system 100 to interconnect each of the original data fragments using redundant data portions. In this fashion, the parity data generated by erasure code encoder module 121 allows memory storage system 100 to build an information correlation among all data fragments that include the original data fragments and the parity data fragments.

For example, in an embodiment, for one erasure code, erasure code encoder module 121 defines its related code word as v=[u p], where v is a 1×n vector, u is a 1×k vector, and p is a 1×m vector. As illustrated by Equation 1 below, the erasure code has a parity check matrix H (dimensioned as k rows with n columns) which consists of 2 submatrices H₁ and H₂, correspondingly. By row and column permutation, H₂ is constructed as a full-rank matrix, which can be expressed as, for example, R(A)=k. This non-singular property delivers the inverse matrix of H₂. The original data fragments u can be calculated using the parity fragments p. For instance, this calculation can be performed using the dot production of matrix Λ and vector u. In some embodiments, matrix Λ can be stored by erasure code encoder module 121 in a data structure or memory resident on memory storage system 100.

$$∵ H \cdot {v}^{t} = [ {H}_{1} {H}_{2} ] \cdot [ \begin{matrix}u \\ p\end{matrix} ] = 0 \\ ∴ {H}_{1} \cdot u = {H}_{2} \cdot p \\ ∴ p = {H}_{2}^{- 1} \cdot {H}_{1} \cdot u = Λ \cdot u \qquad Equation 1$$

Generally, different fragments of vector u can be sequentially processed by erasure code encoder module 121. As such, erasure code encoder module 121 includes the functionality to process data fragments as they are received (as expressed in Equation 2) rather than waiting for all original data fragments to be received prior to generating parity data.

$$[ \begin{matrix}{Λ}_{11} & {Λ}_{12} & {Λ}_{13} & … & {Λ}_{\text{?}} \\ {Λ}_{21} & {Λ}_{22} & {Λ}_{23} & … & {Λ}_{\text{?}} \\ & … & … & & \\ {Λ}_{\text{?}} & {Λ}_{\text{?}} & {Λ}_{\text{?}} & … & {Λ}_{\text{?}}\end{matrix} ] \cdot [ \begin{matrix}{u}_{1} \\ {u}_{2} \\ {u}_{3} \\ … \\ {u}_{\text{?}}\end{matrix} ] = [ \begin{matrix}{Λ}_{\text{?}} \cdot {u}_{\text{?}} \\ {Λ}_{\text{?}} \cdot {u}_{\text{?}} \\ … \\ {Λ}_{\text{?}} \cdot {u}_{\text{?}}\end{matrix} ] + [ \begin{matrix}{Λ}_{\text{?}} \cdot {u}_{\text{?}} \\ {Λ}_{\text{?}} \cdot {u}_{\text{?}} \\ … \\ {Λ}_{\text{?}} \cdot {u}_{\text{?}}\end{matrix} ] + … + [ \begin{matrix}{Λ}_{\text{?}} \cdot {u}_{\text{?}} \\ {Λ}_{\text{?}} \cdot {u}_{\text{?}} \\ … \\ {Λ}_{\text{?}} \cdot {u}_{\text{?}}\end{matrix} ] = {η}_{1} + {η}_{2} + … + {η}_{\text{?}} \\ \text{?} \text{indicates text missing or illegible when filed} \qquad Equation 2$$

As original data fragments arrive, erasure code encoder module 121 multiplies the fragment portions of the store matrix Λ. Meanwhile, the product vectors are accumulated to get the intermediate result of the parity vector, as depicted in Equation 3 below.

$${μ}_{i} = {\sum }_{j = 1}^{i} {η}_{j} \qquad Equation 3$$

Erasure code encoder module 121 also includes the functionality to store each of the original data fragments and/or parity data into separate memory storage devices, such as different NAND dies. For instance, with further reference to Equation 3, as the index of intermediate result μᵢ, i, increases from 1 to k, the parity fragments are ready to be programmed into memory storage devices, such as NAND flash dies that can be grouped based on procedures performed by components of memory storage system 100, such as data fragment grouping module 124.

Erasure code decoder module 120 includes the functionality to optionally decode resultant data generated by erasure code encoder module 121. Erasure code decoder module 120 includes the functionality to use data fragments generated by erasure code encoder module 121 to restore the data into its original form using parity data stored in a separate memory storage device resident on memory storage system 100. Also, erasure code decoder module 120 includes the functionality to determine whether to decode resultant data generated by erasure code encoder module 121 depending on certain conditions, such as whether the error correction coding is efficient, the destination die is available, the data pattern needs pre-fetch, etc.

Data fragment grouping module 124 includes the functionality to group a number of different data fragments that are stored within separate NAND flash dies. Data fragment grouping module 124 generates grouped data sets which include data fragments and/or parity data. Parity data is generated for each data fragment and can be communicated through different data channels and stored by multiple memory storage devices (e.g., at least two NAND dies).

In this fashion, data fragment grouping module 124 generates several units of grouped data in which the data fragments grouped therein are closely related. Using the data fragments in each respective grouped data set, data written to a particular NAND die can be restored to a form prior to fragmentation (or an “original form”) using the data fragments (e.g., redundant data fragments, parity data) stored in a completely different NAND die. According to some embodiments, information related to grouped data sets containing data fragments can be stored in a data structure, memory resident on memory storage system 100 or another location that is accessible to data fragment grouping module 124.

Error correction encoder module 122 includes the functionality to encode resultant data generated by erasure code encoder module 121. Error correction decoder module 123 includes the functionality to decode resultant data stored from memory storage devices, such as those stored in NAND dies and/or DRAM dies. In this fashion, error correction decoder module 123 is configured to translate error correction code data read operation operations performed on resultant data stored in memory storage devices.

FIG. 1B is a block diagram depicting an example of a hardware configuration for reducing memory storage latency and improving memory storage robustness in accordance with embodiments of the present disclosure. Although specific components are disclosed in FIG. 1B, it should be appreciated that such components are exemplary. That is, embodiments of the present disclosure are well suited to having various other hardware components or variations of the components recited in FIG. 1B. It is appreciated that the hardware components in FIG. 1B can operate with components other than those presented, and that not all of the hardware components described in FIG. 1B are required to achieve the goals of the present disclosure. According to some embodiments, components depicted within FIG. 1B can be combined to achieve the goals of the present disclosure. Furthermore, it is appreciated that some components described in FIG. 1B can operate in combination with some components described in FIG. 1A for purposes of achieving the goals of the present disclosure.

According to an embodiment, memory storage system 100 includes at least one processing unit 101, a memory storage unit such as computer storage medium 102, NAND dies 103 and/or DRAM dies 104. As described herein, memory storage system 100 can be implemented as an electronic device capable of communicating with other electronic devices through data communications bus 106. Depending on the exact configuration and type of device, computer readable storage medium 102 can be volatile (such as RAM), non-volatile (such as ROM, flash memory) or some combination of the two. Portions of computer readable storage medium 102, when executed, facilitate efficient execution of memory operations or requests for groups of threads.

In an embodiment, processor 101 can be a programmable circuit configured to perform operations described herein (e.g., operations performed by components described in FIG. 1A). For example, processor 101 can be a FPGA controller or a flash memory device controller. Alternatively, in an embodiment, processor 101 can be operable to execute a program stored in non-transitory computer readable storage medium 102 and configured to perform operations described herein (e.g., operations performed by components described in FIG. 1A). Additionally, system 100 may also have additional features and functionality. For example, system 100 may also include additional storage media (removable and/or non-removable) including, but not limited to, magnetic or optical disks or tape. Computer storage media includes volatile and nonvolatile, removable and non-removable media implemented in any method or technology for storage of information such as computer readable instructions, data structures, program modules or other data. The increased capacity of memory storage system 100 allows for dozens of NAND flash dies and/or DRAM dies to reside on a same PCB.

NAND dies 103 includes a number of different NAND dies (or “NAND flash devices”). Each NAND die of NAND dies 103 includes the functionality to store data therein. For instance, NAND dies 103 can each store original data fragments, redundant data fragments, parity data, and/or other data. In this manner, NAND dies 103 allow memory storage system 100 to build an information correlation among all data fragments that include the original data fragments, redundant data and/or the parity data fragments. Each NAND die capacity can be, for instance, 1G bits or more. In this fashion, each NAND die can have hundreds of data blocks that stores tens of M bytes. As such, one data block can have tens of pages in which each page has 16 k Bytes, 8 k Bytes, etc. By coupling multiple channels to send and receive signals from one or more NAND dies, memory storage system 100 can generate a number of different data fragments from data that is to be written to one or more NAND dies.

Additionally, each NAND die of NAND dies 103 includes the functionality to send and receive signals from other components of memory storage system 100, such as SSD controller 110. Moreover, each NAND die of NAND dies 103 includes the functionality to send and receive signals from components of memory storage system 100 through a respective channel from channels 115.

DRAM dies 104 includes a number of different DRAM dies. Each DRAM die of DRAM dies 104 includes the functionality to store data therein. Each DRAM die of DRAM dies 104 includes the functionality to send and receive signals from other components of memory storage system 100, such as SSD controller 110 and/or DRAM Controller 113. For instance, each DRAM die of DRAM dies 104 includes the functionality to send and receive signals from DRAM controller 113 through DRAM interface module 114. In this fashion, DRAM dies 104 use configurations determined by DRAM Controller 113 to enable a host device to map DRAM dies 104 into virtual memory space for a particular resource or I/O device. As such, other host devices and/or other devices can perform read and/or write data procedures involving DRAM dies 104 using DRAM Controller 113 and/or DRAM interface module 114.

FIG. 1C illustrates an example of a circuit that can be used to implement erasure coding for parity generation in accordance with embodiments of the present disclosure. Erasure code encoder module 121 includes the functionality to store parity data in memory storage devices as binary bits. For instance, as depicted in part (a) and (b) of FIG. 1C, erasure code encoder module 121 can perform multiplication and addition operations on the binary field which are respectively equivalent to the AND and XOR gates. With further reference to part (c) of FIG. 1C, each time a data fragment uᵢ arrives, it is operated on (e.g., “ANDed”) with one submatrix Λᵢⱼ read from a ROM and XORed with the corresponding row of μ. As such, each uᵢ is operated on with all m submatrices of Λ in the current column.

FIG. 1D illustrates an example of a memory storage system configuration with multiple channels and multiple NAND flash dies in accordance with embodiments of the present disclosure. The memory storage system 100 illustrated in FIG. 1D can include multiple channels, such as channels 115-1, 115-2, 115-3, and 115-4, in which each channel can be configured to send and receive signals from one or more memory storage devices. For instance, as illustrated in FIG. 1D, channel 115-1 is configured to send and receive signals from NAND die 103-1, 103-2, and 103-3. Also, channel 115-2 is configured to send and receive signals from NAND die 103-4, 103-5, and 103-6. Additionally, channel 115-3 is configured to send and receive signals from NAND die 103-7, 103-8, and 103-9. Moreover, channel 115-4 is configured to send and receive signals from NAND die 103-10, 103-11, and 103-12.

FIG. 1E illustrates an example of a data path used by a memory storage system in accordance with embodiments of the present disclosure. The data path used by memory storage system 100 includes both a write path and a read path. As illustrated by the embodiment depicted in FIG. 1E, the write path can start, for example, upon receipt of data write instructions from an application by host interface module 112. The write path may include further processing by CRC encoder module 117, encryption module 119, erasure code encoder module 121 and/or data fragment grouping module 124, and error correction encoder module 122. As described herein, memory storage system 100 is coupled to NAND dies 103 via channels 115 or another interface type (e.g., an Open NAND Interface, ONFI). Data can be moved to NAND dies 103 using a synchronous and asynchronous trigger mode (toggle).

Data is moved to the read path from the NAND dies 103 via the same toggle mechanism and channels 115. The read path may include further processing by error correction decoder module 123, erasure code decoder module 120, decryption module 118, and a CRC encoder module 116. The read path may then include data communicated to the application, which originally issued the write operation, via host interface module 112. Furthermore, as depicted in FIG. 1E, switch 130 may be used to trigger or bypass erasure code decoding procedures.

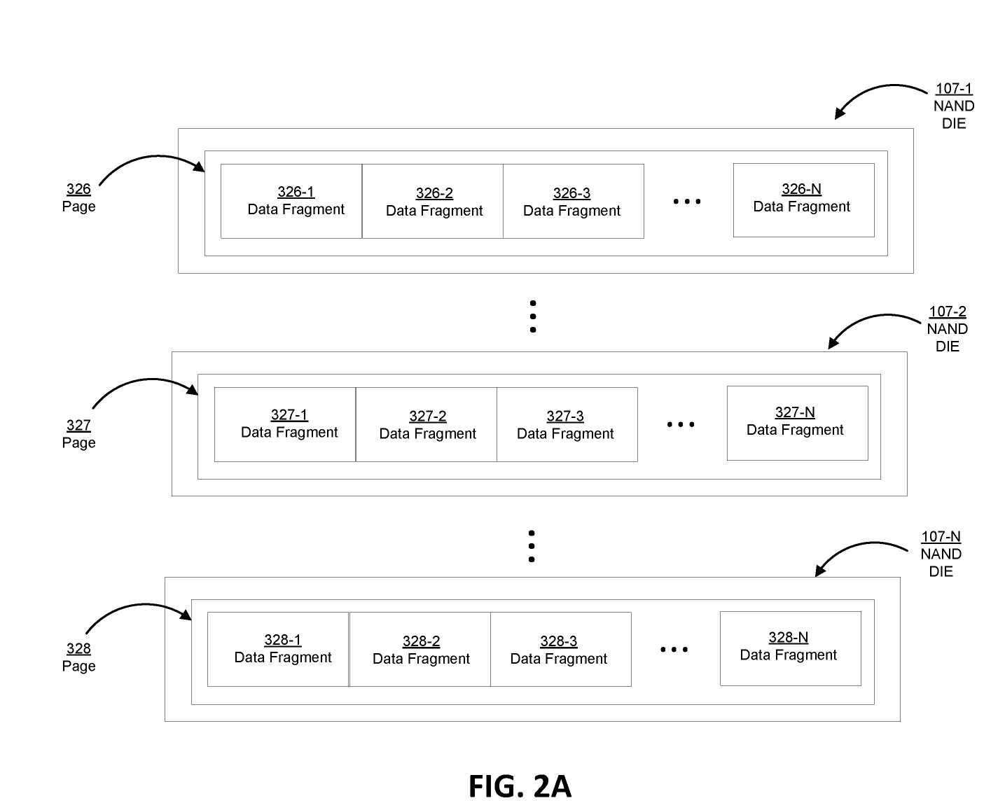

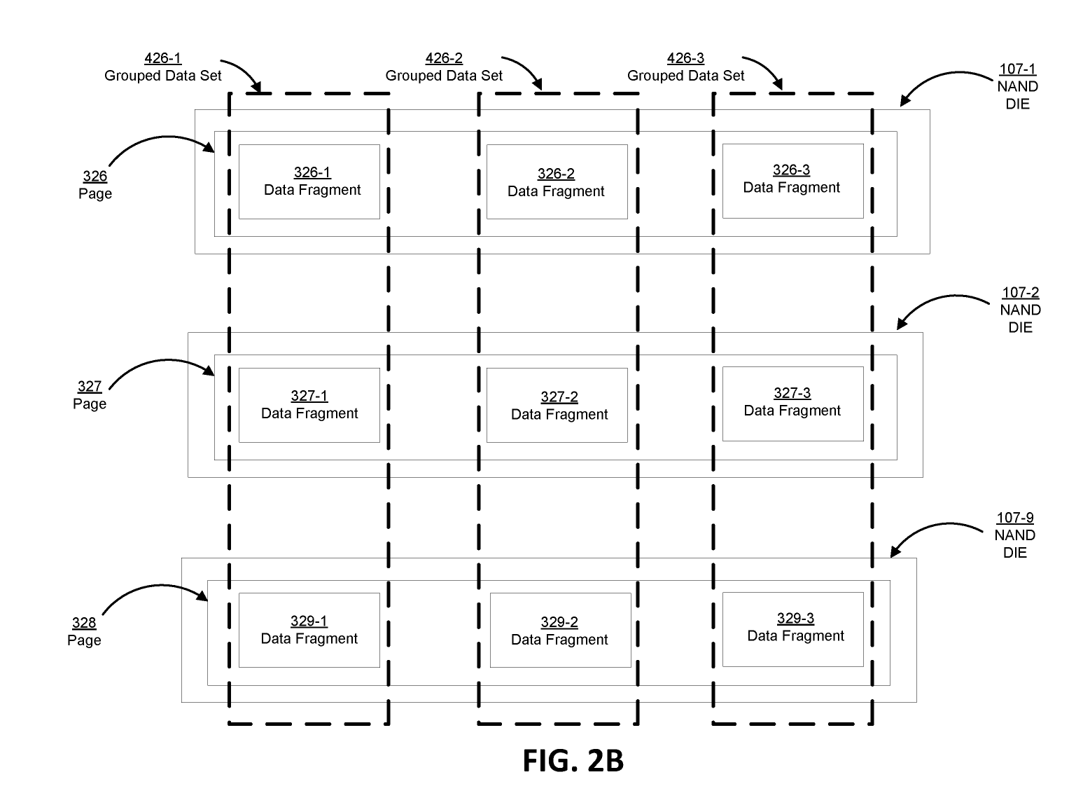

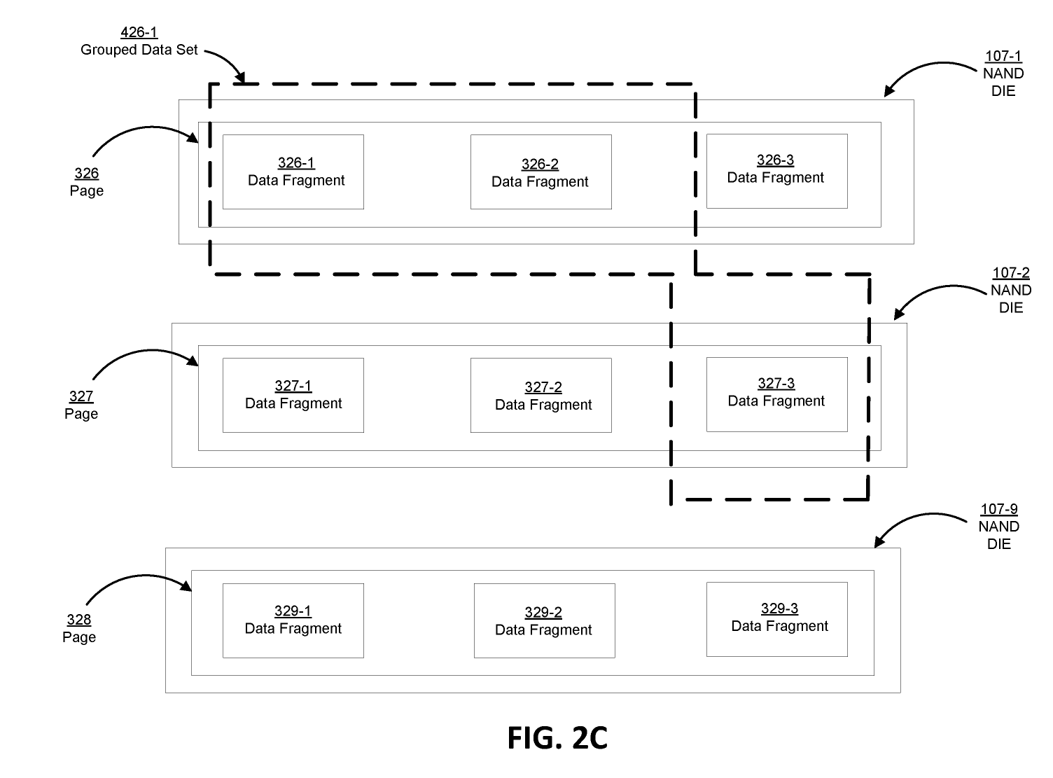

FIG. 2A is a block diagram depicting an example of a data fragmentation process for performing data restoration procedures in accordance with embodiments of the present disclosure. As illustrated in FIG. 2A, erasure code encoder module 121 generates a number of different data fragments from data that is to be written to one or more NAND dies, thereby creating a number of redundant data fragments and/or parity data fragments. Moreover, data fragments for the same original data can be distributed across different NAND dies. For example, in one embodiment, data fragments 326-1, 327-1 and 328-1 can be separate data fragments stored in separate NAND dies (e.g., NAND dies 107-1, 107-2, 107-N, respectively) that can each be used independently to restore data to an original form, prior to data fragmentation, in response to an application issuing a “read” operation for the original form of the data. In one embodiment, each data fragment, such as data fragments 326-1 through 328-N, can store 8 bytes of data and 1 symbol byte.

These data fragments can be stored in fixed-length contiguous blocks of memory, such as page memory within a respective die, respectively. For instance, as depicted in FIG. 2A, page memory 326 can store a number of different data fragments such as data fragments 326-1, 326-2, 326-3, data fragment 326-N, etc., within NAND die 107-1. Also, page memory 327 can store a separate set of different data fragments such as data fragments 327-1, 327-2, 327-3, data fragment 327-N, etc., within a different memory storage device, such as NAND die 107-2. Furthermore, page memory 328 can store another separate set of different data fragments such as data fragments 328-1, 328-2, 328-3, data fragment 328-N, etc., within a different memory storage device, such as NAND die 107-N.

FIGS. 2B and 2C are block diagrams depicting examples of data grouping procedure in accordance with embodiments of the present disclosure. As depicted in FIGS. 2B and 2C, data fragment grouping module 124 groups a number of different data fragments that are distributed among separate NAND flash dies. For instance, as illustrated in FIG. 2B, data fragment grouping module 124 can generate grouped data set 426-1, which include data fragments 326-1, 327-1 and 329-1. As depicted in FIG. 2C, in one embodiment, grouped data set 426-1 can include more than one data fragment from the same page.

With further reference to the embodiment depicted in FIG. 2B, data fragment grouping module 124 can also generate grouped data set 426-2, which include data fragments 326-2, 327-2 and 329-2. Moreover, data fragment grouping module 124 can generate grouped data set 426-3, which include data fragments 326-3, 327-3 and 329-3. In this fashion, memory storage system 100 takes several pages of memory from each NAND die and forms an interconnection among several NAND dies to form grouped data sets.

In this fashion, data fragment grouping module 124 generates several units of grouped data in which the data fragments grouped therein are closely related. For instance, using the data fragments in each respective grouped data set, data written to a particular NAND die can be restored to an original form using data stored in a completely different NAND die. For instance, with further reference to FIGS. 2B and 2C, data fragments 326-1, 327-1 and 329-1 of grouped data set 426-1 can each be independently associated with a same write command issued from an application.

As such, when a read request is issued by an application requesting the resultant data generated by the write command, memory storage system 100 can restore the desired resultant data to its original form using only data fragments 326-1, 327-1 and 329-1. In this manner, this memory storage system 100 requires reading only any k data fragments out of a group of n data fragments (k<n) to rebuild all the rest n−k data fragments. As a result, memory storage system 100 reduces the read operation applied onto physical pages. When one read request falls onto a NAND die that is currently in the process of being erased, the page memory to be read will be retrieved by the content of the other page memory in the same group.

According to one embodiment, erasure code encoder module 121 is configured to use the minimum distance separation (MDS) code for performing erasure coding procedures. For instance, using MDS code such as Reed Solomon (RS) code (n,k), where n is the total number of fragments in one code and k is the total number of fragments of original data fragments, data fragment grouping module 124 generates data fragment groupings configured to rebuild any n-k data fragments of the n fragments by reading any k fragments of a data fragment group. For example, erasure code encoder module 121 can be configured to use shorten code words, where the code word length n=2⁸−1−7=248 and k=216. Therefore, this code can directly correct 32 erroneous symbols. Each fragment has 8 symbols, so one code word can have 31 data fragments. Each data fragment can be in one NAND flash die, such that one 8K-byte page accommodates 1024 data fragments.

For example, with further reference to FIG. 2A, data fragments 326-1, 327-1, and 328-1 can be configured with a first code word. Also, data fragments 326-2, 327-2, and 328-2 can be configured with a second code word. Additionally, data fragments 326-3, 327-3, and 328-3 can be configured with a third code word. As such, using a subset of the data fragments generated by erasure code encoder module 121, all data fragments related to an original resultant data can be retrieved without actual sensing on the corresponding physical locations. In this fashion, memory storage system 100 is configured to read the least number of fragments to rebuild as many fragments as possible. Thus, when some NAND flash dies are not available to be read (such as the die being locked as a result of being erased, die malfunction, inherent ECC failures, etc.), their contents can nevertheless be retrieved.

FIG. 3 is a flowchart of an exemplary process for reducing memory storage latency and improving robustness in accordance with embodiments of the present disclosure.

At step 301, the memory storage system initiates procedures to process a read request issued by a host device.

As step 302, a flash translation layer (FTL) included in the memory storage system locates a physical page address related to the read request.

At step 303, a determination is made by the memory storage system as to whether the NAND die storing the desired content to be read is currently locked. If the NAND die is not locked, then the memory storage system proceeds to read the contents of the NAND die, as detailed in step 304. If the NAND die is locked, then the memory storage system performs a parallel read operation using the page memory of other NAND dies grouped with the locked NAND die, as detailed in step 305.

As step 304, the NAND die is not locked and, therefore, the memory storage system proceeds to read the contents of the NAND die. Upon completion of the read, the memory storage system completes processing of the read request, as detailed at step 309.

As step 305, the NAND die is locked and, therefore, the memory storage system performs a parallel read operation using the page memory of other NAND dies grouped with the locked NAND die.

As step 306, the memory storage system performs erasure decoding to reproduce the content of the desired page.

As step 307, the memory storage system performs CRC encoding procedures on the reproduced data for transmission to the host interface.

At step 308, a determination is made by the memory storage system as to whether a last memory page has been read. If a last memory page has been read, the memory storage system completes processing of the read request issued by the host device at step 301, as detailed at step 309. If a last memory page has not been read, the memory storage system continues to perform procedures to process the read request issued, as detailed at step 301.

At step 309, a last memory page has been read and, therefore, the memory storage system completes processing of the read request issued by the host device at step 301.

FIG. 4A is a first portion of a flowchart of an exemplary process for performing data fragmenting and data grouping procedures in accordance with embodiments of the present disclosure.

At step 401, the memory storage system receives a first signal from a host device through a network bus to write data to a NAND die from a plurality of NAND dies.

As step 402, the memory storage system allocates memory pages in NAND dies to perform the write procedure based on the instructions issued at step 401 using a respective data channel from a plurality of data channels configured for the memory storage system.

At step 403, using erasure code procedures, the memory storage system fragments the resultant data generated from the write procedure performed during step 402 into a plurality of data fragments. Parity data is generated for each data fragment by the memory storage system. The parity data is communicated through different data channels and stored by at least two NAND dies from the plurality of NAND dies.

FIG. 4B is a second portion of a flowchart of an exemplary process for performing data fragmenting and data grouping procedures in accordance with embodiments of the present disclosure.

At step 404, the memory storage system generates a data grouping for each data fragment related to the resultant data generated from the write procedure performed during step 402.

At step 405, the memory storage system receives a second signal from a host device through a network bus to read the resultant data generated from the write procedure performed during step 402. The second signal includes instructions to access a specified NAND die through a data channel to perform the read procedure.

At step 406, the memory storage system identifies a data group associated with the data sought after by the read operation and correspondingly transmits a third signal to perform the read operation issued during step 405. The third signal includes multiple read operation signals communicated in parallel to each NAND die storing a data fragment related to the read operation.

At step 407, the memory storage system restores the sought after data of the read operation to an original form using data fragments included in the data group identified during step 406 and communicates the data to the host device seeking the data.

Although exemplary embodiments of the present disclosure are described above with reference to the accompanying drawings, those skilled in the art will understand that the present disclosure may be implemented in various ways without changing the necessary features or the spirit of the present disclosure. The scope of the present disclosure will be interpreted by the claims below, and it will be construed that all techniques within the scope equivalent thereto belong to the scope of the present disclosure.

According to an embodiment, the techniques described herein are implemented by one or more special-purpose computing devices. The special-purpose computing devices may be hardwired to perform the techniques; may include digital electronic devices, such as one or more application-specific integrated circuits (ASICs) or field programmable gate arrays (FPGAs) that are persistently programmed to perform the techniques; or may include one or more general purpose hardware processors programmed to perform the techniques pursuant to program instructions in firmware, memory, other storage, or a combination. Such special-purpose computing devices may also combine custom hardwired logic, ASICs, or FPGAs with custom programming to accomplish the techniques. The special-purpose computing devices may be database servers, storage devices, desktop computer systems, portable computer systems, handheld devices, networking devices, or any other device that incorporates hardwired and/or program logic to implement the techniques.

In the foregoing detailed description of embodiments of the present disclosure, numerous specific details have been set forth in order to provide a thorough understanding of the present disclosure. However, it will be recognized by one of ordinary skill in the art that the present disclosure is able to be practiced without these specific details. In other instances, well-known methods, procedures, components, and circuits have not been described in detail so as not to unnecessarily obscure aspects of the embodiments of the present disclosure.

Although a method is able to be depicted as a sequence of numbered steps for clarity, the numbering does not necessarily dictate the order of the steps. It should be understood that some of the steps may be skipped, performed in parallel, or performed without the requirement of maintaining a strict order of sequence. The drawings showing embodiments of the disclosure are semi-diagrammatic and not to scale and, particularly, some of the dimensions are for the clarity of presentation and are shown exaggerated in the Figures. Similarly, although the views in the drawings for the ease of description generally show similar orientations, this depiction in the Figures is arbitrary for the most part.

Embodiments according to the present disclosure are thus described. While the present disclosure has been described in particular embodiments, it is intended that the disclosure shall be limited only to the extent required by the appended claims and the rules and principles of applicable law.

What is claimed is:

1. An apparatus comprising:
a communication interface configured to communicate with a plurality of memory storage devices; and
a processor coupled to said communication interface and configured to:
execute a write operation to write an original form of data into a first memory storage device of said plurality of memory storage devices, wherein execution of said write operation generates resultant data;
fragment said resultant data into a plurality of data fragments, wherein at least some data fragments of said plurality of data fragments are stored by a respective memory storage device of said plurality of memory storage devices; and
during execution of a read operation to read data related to said resultant data, restore said resultant data to said original form using a first data fragment of said plurality of data fragments, said first data fragment stored in a second memory storage device of said plurality of memory storage devices.

2. The apparatus as described in claim 1, wherein said processor is configured to group a set of data fragments from said plurality of data fragments to produce a first grouped data set, wherein said first grouped data set is configured to restore said resultant data to said original form using a first data fragment from said first grouped data set.

3. The apparatus as described in claim 1, wherein said processor is configured to restore said resultant data during a locked status period for said first memory storage device.

4. The apparatus as described in claim 3, wherein said second memory storage device is not experiencing a locked status period.

5. The apparatus as described in claim 1, wherein said processor is configured to fragment said resultant data using an erasure coding procedure.

6. The apparatus as described in claim 5, wherein said erasure coding procedure comprises a minimum distance separation (MDS) scheme.

7. The apparatus as described in claim 1, wherein said plurality of memory storage devices are NAND dies.

8. The apparatus as described in claim 1, wherein said communication interface comprises a plurality of data channels, wherein each data channel is communicatively coupled to a respective NAND die of said plurality of NAND dies.

9. A computer-implemented method comprising:
executing a write operation to write data into a first memory storage device of said plurality of memory storage devices, wherein execution of said write data generates resultant data;
fragmenting said resultant data into a plurality of data fragments, wherein at least some data fragments of said plurality of data fragments are stored by a respective memory storage device of said plurality of memory storage devices; and
during execution of a read operation to read data related to said resultant data, restoring said resultant data to an original form using a first data fragment of said plurality of data fragments, said first data fragment stored in a second memory storage device of said plurality of memory storage devices.

10. The computer-implemented method as described in claim 9, further comprising:
grouping a set of data fragments from said plurality of data fragments to produce a first grouped data set, wherein said first grouped data set is configured to restore said resultant data to said original form using a first redundant data fragment from said first grouped data set.

11. The computer-implemented method as described in claim 9, wherein restoring further comprises restoring said resultant data during a locked status period for said first memory storage device.

12. The computer-implemented method as described in claim 11, wherein said second memory storage device is not experiencing a locked status period.

13. The computer-implemented method as described in claim 9, wherein fragmenting further comprises fragmenting said resultant data using an erasure coding procedure.

14. The computer-implemented method as described in claim 13, wherein said erasure coding procedure comprises a minimum distance separation (MDS) scheme.

15. An apparatus comprising:
a plurality of data channels, wherein each data channel is communicatively coupled to a respective NAND die from a plurality of NAND dies; and
a processor communicatively coupled to said plurality of data channels and configured to:
receive data signals from said plurality of NAND dies and send data signals thereto;
execute a write operation to write data into a first NAND die of said plurality of NAND dies, wherein execution of said write data generates resultant data;
fragment said resultant data into a plurality of redundant data fragments, wherein each redundant data fragment of said plurality of redundant data fragments is stored by a respective NAND die of said plurality of NAND dies; and
group a set of redundant data fragments from said plurality of redundant data fragments to produce a first grouped data set, wherein said first grouped data set is configured to restore said resultant data to said original form using a first redundant data fragment from said first grouped data set;
during execution of a read operation to read data related to said resultant data, restore said resultant data to an original form by reading said first redundant data fragment.

16. The apparatus as described in claim 15, wherein said processor is configured to fragment portions of said resultant data as said resultant data is received in real-time.

17. The apparatus as described in claim 15, wherein said processor is configured to restore said resultant data to said original form using an erasure decoding procedure.

18. The apparatus as described in claim 17, wherein said erasure decoding procedure comprises a minimum distance separation (MDS) scheme.

19. The apparatus as described in claim 15, wherein said redundant data fragments comprise parity data.

20. The apparatus as described in claim 15, wherein said processor is configured to read said first subset of said plurality of redundant data fragments by performing a parallel read operation on said first subset.
